(19) United States
(12) Patent Application Publication
(10) Pub. No.: US 2012/0293378 A1
(43) Pub. Date: Nov. 22, 2012

(54) ANTENNA ARRANGEMENT FOR A PORTABLE RADIO COMMUNICATION DEVICE HAVING A METAL CASING

(76) Inventor: Axel von Arbin, Taby (SE)

(21) Appl. No.: 13/470,501

(22) Filed: May 14, 2012

(30) Foreign Application Priority Data
May 17, 2011 (EP) 11166376.1

(51) Int. Cl. H01Q 1/24

(52) U.S. Cl. 343/702

(57) ABSTRACT

An exemplary embodiment includes an antenna arrangement for a portable radio communication device having a metal casing. The antenna arrangement generally includes a first antenna device and a second antenna device. The first antenna device comprises the metal casing and has a first radiating antenna pattern. The second antenna device has a second radiating antenna pattern. The second antenna device is outside the metal casing.

### CROSS-REFERENCE TO RELATED APPLICATION

This application claims priority of European patent application No. 11166376.1 filed May 17, 2011. The entire disclosure of the above application is incorporated herein by reference.

### FIELD

The present disclosure relates to antenna arrangements for portable radio communication devices having metal casings.

### BACKGROUND

This section provides background information related to the present disclosure which is not necessarily prior art.

A current trend for portable radio communication devices, such as mobile phones, PDAs, portable computers, and similar devices, is to provide the device with a metal casing or cover. But a metal casing for a portable radio communication device makes it difficult to provide the device with a non-protruding antenna, as the metal casing shields the interior of the device for radio frequencies. Thus, it is possible to only partly provide the casing as a metal casing to allow the use of a built in antenna. The inventor hereof has recognized that it would be desirable to provide an antenna arrangement having a full metal casing.

Another trend for portable radio communication devices, such as mobile phones and similar devices, is to provide the device with very broadband overage or a wide coverage of frequency bands, covering e.g. LTE700, GSM850, GSM900, GSM1800, GSM1900, UMTS2100, LTE2300, and LTE2600. This puts further restrictions on the design of an antenna for a portable radio communication device.

### SUMMARY

This section provides a general summary of the disclosure, and is not a comprehensive disclosure of its full scope or all of its features.

Exemplary embodiments are disclosed of antenna arrangements for portable radio communication devices having metal casings or covers which antenna arrangements also allow or provide the possibility for multi-band operation. Also disclosed are exemplary embodiments of portable radio communication devices including such antenna arrangements and metal casings.

An exemplary embodiment includes an antenna arrangement for a portable radio communication device having a metal casing. The antenna arrangement generally includes a first antenna device and a second antenna device. The first antenna device comprises the metal casing and has a first radiating antenna pattern. The second antenna device has a second radiating antenna pattern. The second antenna device is outside the metal casing.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 schematically shows a front side of a metal casing for a mobile phone.

FIG. 2 schematically shows a back side of a metal casing for a mobile phone according to a first exemplary embodiment.

FIG. 3 schematically shows a side view from the left of a variant of the metal casing shown in FIG. 2.

FIG. 4 schematically shows a side view from the right of a variant of the metal casing shown in FIG. 2.

FIG. 5 schematically shows a back side of a metal casing for a mobile phone according to a second exemplary embodiment.

FIG. 6 schematically shows a back side of a metal casing for a mobile phone according to a third exemplary embodiment.

FIG. 7 schematically shows a back side of a metal casing for a mobile phone according to a fourth exemplary embodiment.

FIG. 8 schematically shows a side view of a metal casing for a mobile phone according to a fifth exemplary embodiment.

FIG. 9 schematically shows a side view of a metal casing for a mobile phone according to a sixth exemplary embodiment.

FIG. 10 schematically shows a side view of a metal casing for a mobile phone according to a seventh exemplary embodiment.

FIG. 11 schematically shows a back side and a side view of a metal casing for a mobile phone according to an eighth exemplary embodiment.

FIG. 12 schematically shows a perspective view of a back side of an antenna arrangement having first and second antenna devices according to an exemplary embodiment.

FIG. 13 schematically shows a dual-loop, multi-band antenna that may be used in the antenna arrangement shown in FIG. 12 according to an exemplary embodiment.

FIG. 14 schematically shows a monopole, off-ground, multi-band antenna that may be used in the antenna arrangement shown in FIG. 12 according to an exemplary embodiment.

FIG. 15 schematically shows a monopole, on-ground, multi-band antenna that may be used in the antenna arrangement shown in FIG. 12 according to an exemplary embodiment.

FIG. 16 schematically shows a PILA, multi-band antenna that may be used in the antenna arrangement shown in FIG. 12 according to an exemplary embodiment.

FIG. 17 schematically shows a PIFA, multi-band antenna that may be used in the antenna arrangement shown in FIG. 12 according to an exemplary embodiment.

FIG. 18 schematically shows a perspective view of a front side an antenna arrangement having a metal casing with two cavities according to an exemplary embodiment.

### DETAILED DESCRIPTION

Example embodiments will now be described more fully with reference to the accompanying drawings.

Exemplary embodiments are disclosed of antenna arrangements for portable radio communication devices having metal casings or covers which antenna arrangements also allow or provide the possibility for multi-band operation. Also disclosed are exemplary embodiments of portable radio communication devices including such antenna arrangements and metal casings.

In an exemplary embodiment of an antenna arrangement for a portable radio communication device having a metal casing, the antenna arrangement generally includes first and second antenna devices. The first antenna device comprises the metal casing and has a first radiating antenna pattern. The second antenna device has a second radiating antenna pattern essentially uncorrelated to the first radiating antenna pattern. The second antenna device is outside the metal casing. This exemplary embodiment of the antenna arrangement allows multi-band operation, e.g., for a mobile phone having a metal casing.

In an exemplary embodiment, the first antenna device includes a front side part of the metal casing, a first back side part connected to the front side part through a top side part of the metal casing, and a second back side part connected to the front side part through a bottom side part of the metal casing. The bottom and top side parts are positioned at opposite ends of the front side part. The first and second back side parts are positioned and spaced apart or distanced from each other by a gap. The second back side part includes a feed point positioned at or adjacent the gap, such that a very directive far-field radiating antenna pattern is achievable. The second antenna device preferably includes a multi-band antenna structure. The front side part of the metal casing is a ground plane device shared by the first and second antenna devices. By having the second antenna device configured to be operable with a non-directive far-field radiating antenna pattern, a low envelope correlation coefficient between the two antenna devices is achieved, whereby they can be arranged to have a common ground plane device.

The feed point of the second back side part is positioned at or adjacent a corner at the gap, to provide a maximum (or increased) resonating length for the first antenna device. The first back side part preferably includes a feed point positioned at or adjacent the gap, to provide a broad frequency band. The feed point of the first back side part is preferably positioned adjacent the feed point of the second back side part to facilitate feeding to the first antenna device.

To provide the portable radio communication device with a metal casing without protruding non-metal parts, the metal casing may preferably include one or more indentations. The second antenna device is preferably arranged in these indentations of the metal casing. To provide the second antenna device as a main antenna covering and/or operable within a frequency range from about 700 Megahertz (MHz) to about 2600 MHz, the second antenna device is preferably arranged off-ground relative to the ground plane device. To increase the mechanical robustness of the first antenna device, the first and second back side parts preferably include edge portions folded towards the front side part. To increase the bandwidth of the first antenna device, the back side part preferably protrudes outside of the front side part. The first and second back side parts may preferably have gap edge profiles that are preferably essentially mirror-shaped to, e.g., accommodate a camera in the gap.

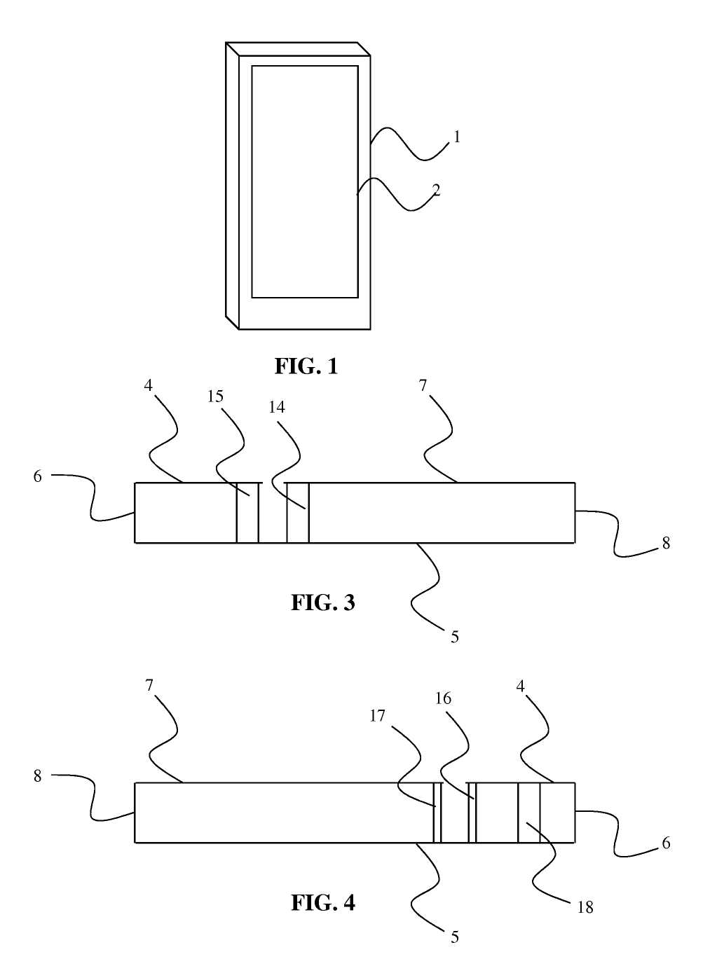

With reference now to FIGS. 1, 2, and 12, a first exemplary embodiment of a portable radio communication device comprising a metal casing and an antenna arrangement will now be described. As shown in FIG. 1, the portable radio communication device (e.g., mobile phone, etc.) includes a sheet metal casing 1 and a touch screen display 2 mounted in or on a front side part of the sheet metal casing 1. Components for operation of the portable radio communication device are as usually provided within its housing, i.e. in this case within the sheet metal casing 1. In this example, the display 2 is a touch-screen display, but could alternatively, e.g., be provided with a display and a separate key pad.

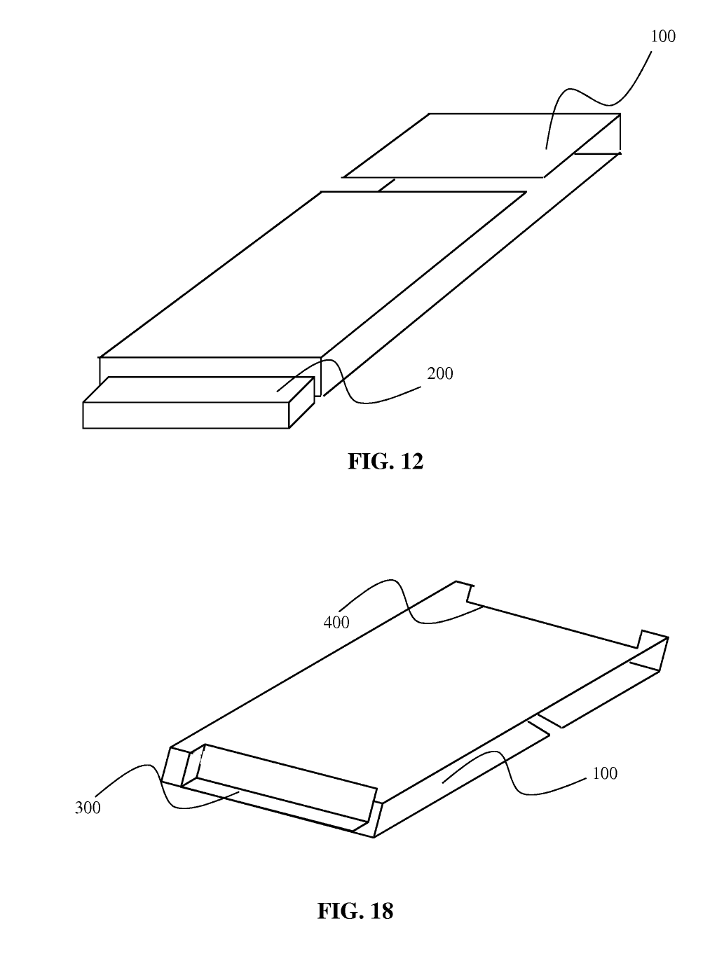

As shown in FIG. 12, the antenna arrangement includes a first antenna device 100 comprising the metal casing and a second antenna device 200. The second antenna device 200 is arranged outside the metal casing. The second antenna device 200 is schematically illustrated having a box-like shape. In practice, a mobile phone and in this example thus the metal casing is designed to have an ergonomic or organic shape. The first antenna device 100 is configured to be operable with and has a first radiating antenna pattern. The second antenna device 200 is configured to be operable with and has a second radiating antenna pattern essentially uncorrelated to the first radiating antenna pattern.

The first antenna device 100 preferably has a very directive far-field radiating antenna pattern. The second antenna device 200 preferably has a non-directive far-field radiating antenna pattern. The first and second antenna devices 100, 200 will thus have a low envelope correlation coefficient, which will allow the two antenna devices 100, 200 to be arranged or configured to provide diversity function while having or sharing a common ground plane device. The low envelope correlation coefficient between the antenna patterns preferably refers only to the low frequency bands, which typically is for frequencies below 1 Gigahertz (GHz) for mobile phones. This is advantageous, because it is very difficult to provide directive patterns for low frequency bands but it is easier to provide directive patterns for high frequency bands. As it is easier to provide directive patterns for high frequency bands, it is also easier to provide two closely spaced antenna devices having non-correlated directive patterns, whereas it is very difficult to provide different patterns for low frequency bands.

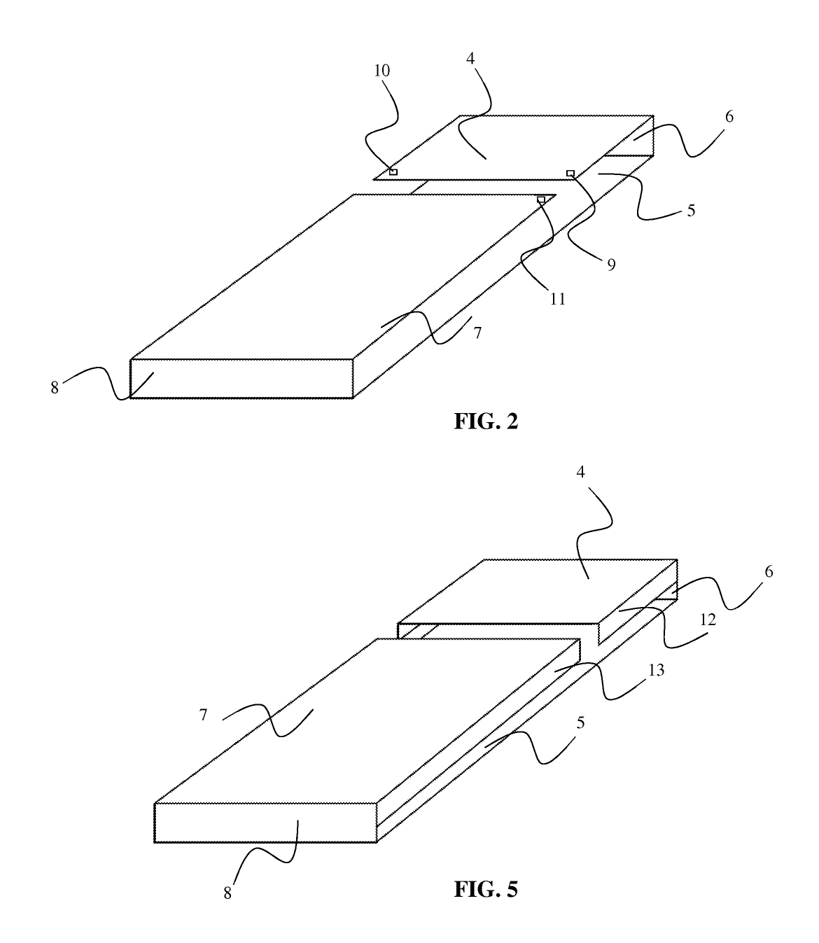

The first antenna device 100 (FIG. 12) comprises the metal casing 1 (FIG. 1), which is configured in the following way for multi-band operation. The back piece of the metal casing 1 is divided into two parts, which are a first back side part 4 and a second back side part 7 as shown in FIG. 2. The first back side part 4 is connected to the front side part 5 of the metal casing through a top side part 6. The second back side part 7 is connected to the front side part 5 of the metal casing through a bottom side part 8. The first back side part 4 and the second back side part 7 are positioned and spaced apart or distanced from each other by a gap, for example, a gap from about 2 millimeters to 5 millimeters.

The first back side part 4 is driven as a multi-band high-frequency antenna element by being fed at a feed point 9, preferably at a corner near or adjacent the gap against the second back side part 7 and by being grounded along the top side part 6. For improved functionality, the first back side part 4 is preferably also grounded at a ground point 10 at an opposite corner near or adjacent the gap against the second back side part 7 or at or adjacent the side edge nearer the top side part 6. For a mobile phone, the metal casing may have a length of about 110 millimeters, a width of about 50 millimeters, and a thickness of about 9 millimeters, and a frequency band coverage of about 1550-2600 Megahertz (MHz) may be achieved. The first back side part 4 has a generally rectangular shape having a length of about 33 millimeters and a width of about 50 millimeters, in this example. The first back side part 4 is alternatively, e.g., driven by a feed point positioned approximately in the middle of the gap, which typically provides slightly better bandwidth compared to feeding in the corner of the first back side part. The specific dimensions and other specific numerical values (e.g., frequencies, etc.) provided in this paragraph (and elsewhere in this application) are exemplary in nature and do not limit the scope of the present disclosure. Alternative embodiments may include metal casings and/or radio communication devices that are configured differently (e.g., larger, smaller, non-rectangular shapes, etc.).

The second back side part 7 is driven as a multi-band low-frequency antenna element by being fed at a feed point 11 at a corner near or adjacent the gap against the first back side part 4 and by being grounded along the bottom side part 8. For a mobile phone, the metal casing may have a length of about 110 millimeters, a width of about 50 millimeters, and a thickness of about 9 millimeters, and a frequency band coverage of about 700-1050 MHz may be achievable. The second back side part 7 has a generally rectangular shape having a length of about 72 millimeters and a width of about 50 millimeters, in this example.

The first and second back side parts 4, 7 are functioning as radiating elements over a ground plane, which ground plane in this exemplary embodiment is the front side part 5. In this exemplary embodiment, a robust first antenna device having a very directive far-field radiating antenna pattern is achieved by the first and second back side parts 4, 7, respectively, being connected to the front side part 5 through a large grounding means, which are the top and bottom side parts 6, 8, respectively. A display device and/or a key pad are typically provided with grounded shielding means between the inner of the radio communication device and the display device and/or the key pad. The grounded shielding means then form part of the front side part. Further, in a mobile phone, e.g., having a touch-screen display occupying essentially the whole front thereof, the front side part 5 of the metal casing 1 will then be made up by the shielding means of the touch-screen display.

The first and second back side parts 4, 7 have been described as having feed points 9 and 11. Feeding of the feed points 9 and 11 is advantageously provided as two separate feedings to radio frequency (RF) circuitry, to improve isolation therebetween. But the feeding of the feed points 9 and 11 could alternatively be provided as a common feeding having filtering means to separate signaling to and from RF circuitry.

The second back side part 7 preferably covers the whole battery of the device, e.g., a mobile phone, etc. The second back side part 7 may be pivotable around and/or detachably attached to the bottom side part 8 to facilitate access into the mobile phone, e.g., changing battery or for changing a SIM of the mobile phone.

The top and bottom side parts have been illustrated as parts covering the top and bottom side, respectively, of the portable radio communication device. But can alternatively comprise a plurality of grounding portions together not covering the top or bottom side, respectively. For improved antenna function, the metal casing is preferably made up by or metalized by a good conductive material.

The second antenna device 200 comprises a multi-band antenna structure, and is preferably arranged or configured to be adjacent the second back side part 7 at, along, or adjacent the bottom side part 8. The front side part 5 of the metal casing 1 is a ground plane device shared by the first and second antenna devices 100, 200, even though the second antenna device 200 is arranged off-ground relative to or from the common ground plane device as shown in FIG. 12.

The second antenna device 200 preferably functions as a main antenna for LTE700, GSM850, GSM900, GSM1800, GSM1900 and UMTS2100, and the first antenna device 100 preferably functions as a diversity antenna for GSM850, GSM1900 and UMTS2100. Alternatively, the second antenna device 200 functions as a main antenna for GSM850, GSM900, GSM1800, GSM1900, UMTS2100 and LTE2300, and the first antenna device 100 functions as a diversity antenna for GSM1900 and UMTS2100. Yet alternatively, the second antenna device 200 functions as a main antenna for GSM850, GSM900, GSM1800, GSM1900, UMTS2100 and LTE2600, and the first antenna device 100 functions as a diversity antenna for GSM1900 and UMTS2100. The above selection of different operating bands is dependent on intended geographical use for the mobile phone.

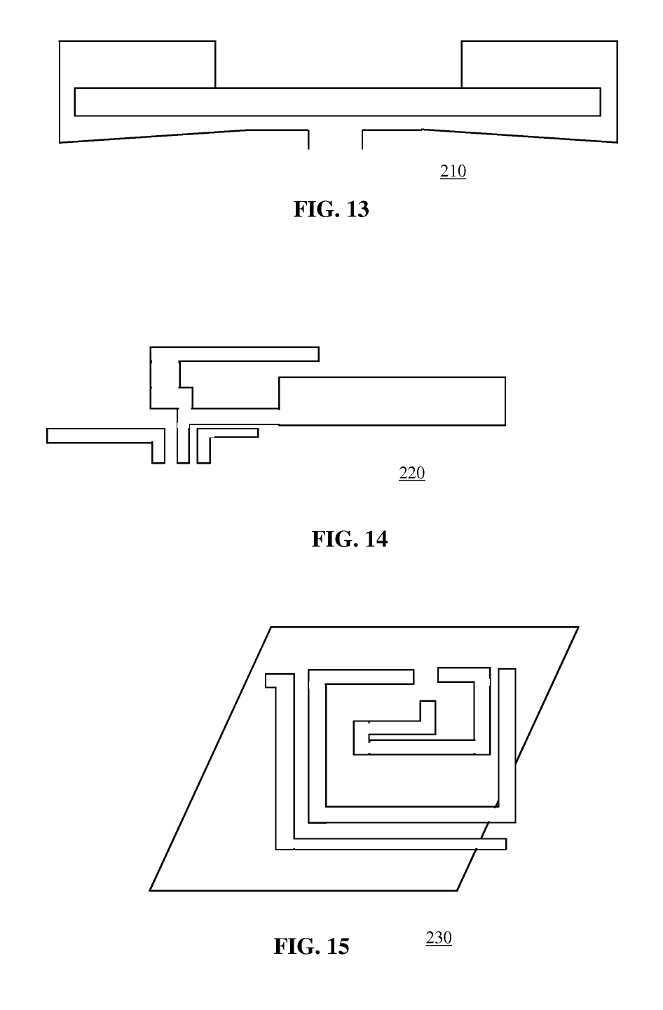

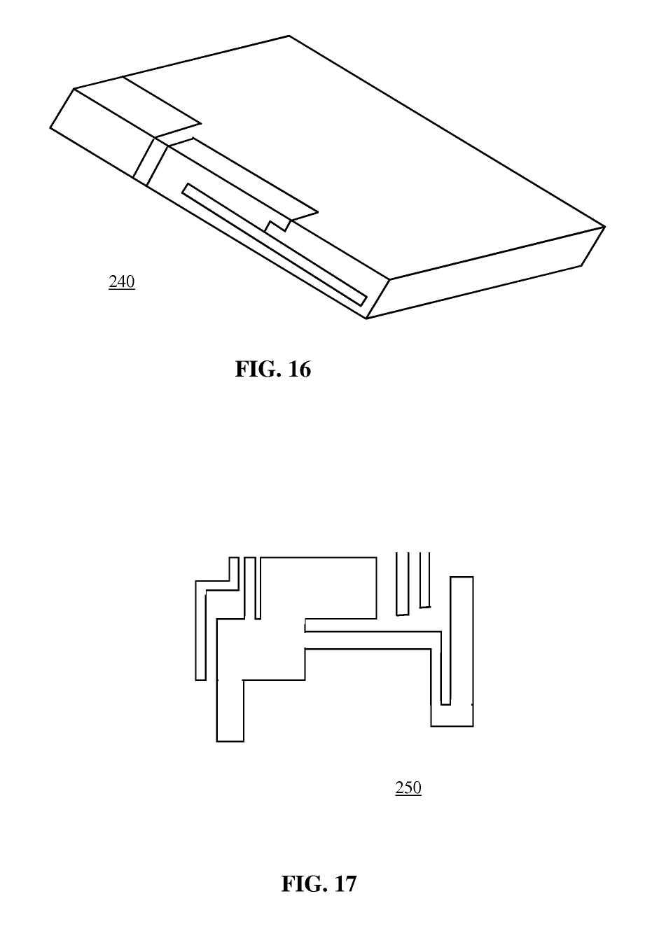

FIGS. 13 through 16 illustrative alternative embodiments of the second antenna device 200. For example, FIG. 13 illustrates an exemplary embodiment in which the second antenna device 200 comprises a dual loop antenna element 210. FIG. 14 illustrates an exemplary embodiment in which the second antenna device 200 comprises an off-ground monopole antenna 220, which may include a plurality of antenna elements. FIG. 15 illustrates an exemplary embodiment in which the second antenna device 200 comprises an on-ground monopole antenna 230, which may include a plurality of antenna elements. FIG. 16 illustrates an exemplary embodiment in which the second antenna device 200 comprises a PILA antenna 240. FIG. 17 illustrates an exemplary embodiment in which the second antenna device 200 comprises a PIFA antenna 250, which may be arranged on-ground. These exemplary antennas have a non-directive far-field radiating antenna pattern, and may easily be configured for the desired operating frequency bands.

For tuning of the first antenna device 100 made up by the metal casing 1, additional grounding is preferably added at the sides of the portable radio communication device. For example, FIG. 3 illustrates a wide grounding 15 to ground point 10 as well as a wide grounding 14 of the second back side part 7. FIG. 4 illustrates an additional wide grounding 18 of the first back side part 4. FIG. 4 also illustrates feeding 16 to feed point 9 and feeding 17 to feed point 11.

Although the first back side part has been described as generating the high frequency band and the second back side part has been described as generating the low frequency band, the opposite is also possible. Also, either the first or the second back side part could generate both low and high frequency bands.

Although the first antenna device 100 of the antenna arrangement has been shown having a straight gap, the first antenna device may alternatively have a curved gap or comprise a cut-out, e.g., for accommodating a camera in the gap. The first and second back side parts 4, 7 may preferably have gap edge profiles that are mirror-shaped.

FIG. 5 illustrates an antenna arrangement according to a second exemplary embodiment. This second embodiment is similar to the first embodiment described above apart from or except that the first and second back side parts 4, 7 comprise folded side edge portions 12, 13 extending towards the front side part 5, extending, for example, about 6 millimeters and thus leaving a gap of about 3 millimeters to the front side part 5. Although the folded side edge portions have been illustrated as covering the whole first and second back side parts 4, 7, it is also possible to only have portions of the first and second back side part edges 12, 13 folded towards the front side part 5.

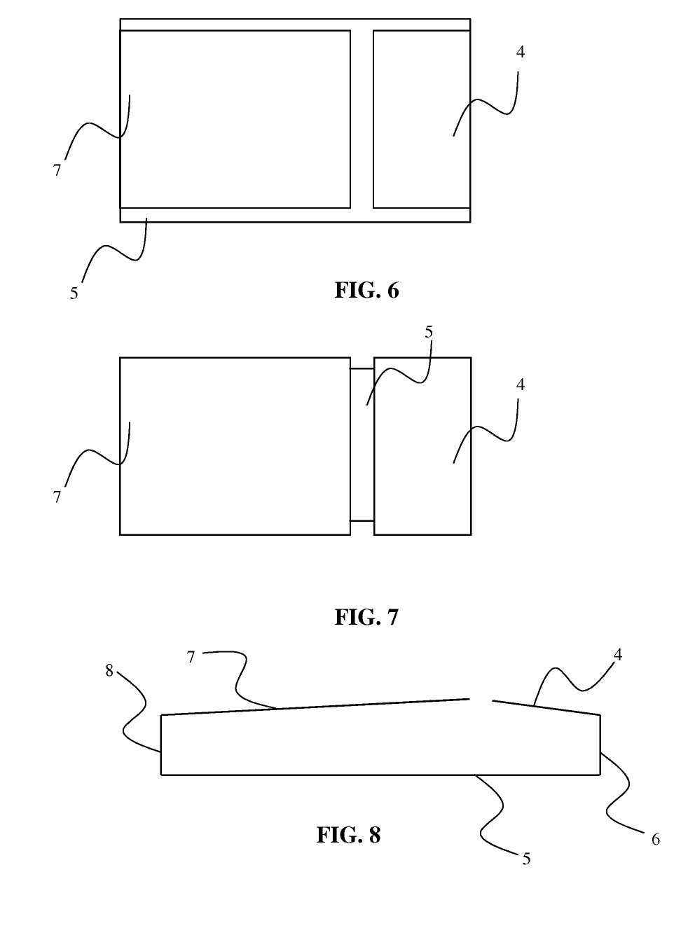

FIG. 6 illustrates an antenna arrangement according to a third exemplary embodiment. This third embodiment is similar to the first embodiment described above apart from or except that the front side part 5 edges are folded towards the back side parts 4, 7, and the first and second back side parts 4, 7 have a smaller extension than the front side part 5. The form of the gap is thus H-shaped in the back piece of the portable radio communication device.

FIG. 7 illustrates an antenna arrangement according to a fourth exemplary embodiment. This fourth embodiment is similar to the first embodiment described above apart from or except that the front side part 5 has a smaller extension than the back side parts 4 and 7. The frequency band coverage of the antenna elements are thus increased by the antenna elements being partly off-ground.

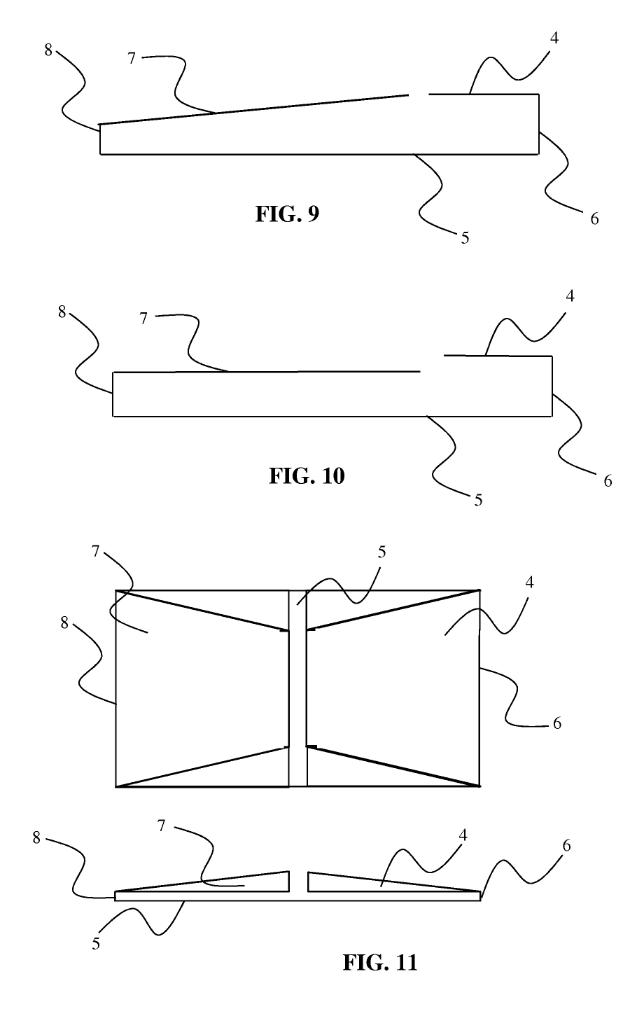

FIG. 8 illustrates an antenna arrangement according to a fifth exemplary embodiment. This fifth embodiment is similar to the first embodiment described above apart from or except that the first and second back side parts 4 and 7 are non-coplanar. The distance between the back side parts 4, 7 and the front side part 5 are greatest at the gap and smallest at the top and bottom side parts 6, 8. In this exemplary way, the portable radio communication device can, e.g., be adapted to have rounded edges, thus allowing a reduced or lower thickness in the outer portions of the portable radio communication device.

FIG. 9 illustrates an antenna arrangement according to a sixth exemplary embodiment. This sixth embodiment is similar to the fifth embodiment described above apart from or except that the first back side part 4 is parallel to the front side part 5, the first back side part 4 is perpendicular to the top side part 6, and the second back side part 7 is tapered towards the bottom side part 8. In this exemplary way, the portable radio communication device can, e.g., be adapted to have rounded edges, thus allowing a reduced or lower thickness in the outer portions of the portable radio communication device.

FIG. 10 illustrates an antenna arrangement according to a seventh exemplary embodiment. This seventh embodiment is similar to the first embodiment described above apart from or except that the distance between the second back side part 7 and the front side part 5 is smaller than the distance between the first back side part 4 and the front side part 5. In this exemplary way, the portable radio communication device can, e.g., be adapted to different volume requirements for different parts of the portable radio communication device.

FIG. 11 illustrates an antenna arrangement according to an eighth exemplary embodiment. This eighth embodiment is similar to the fifth embodiment described above apart from that the first and second back side parts 4, 7 are tapered both towards the top and bottom side parts 6, 8, respectively, as well as tapered towards the side edge parts. The first and second back side parts 4, 7 are not parallel with the front side part 5. In this exemplary manner, this configuration further facilitates a thinner portable radio communication devices, as well as rounded edges all around the portable radio communication device.

FIG. 18 illustrates an antenna arrangement according to a ninth exemplary embodiment. This ninth embodiment is similar to the first embodiment described above apart from the following. In this ninth embodiment, the metal casing comprises a first indentation 300 in the bottom side part, and a second indentation 400 in the top side part, for housing of the second antenna device therein. By providing the second antenna device in indentations of the metal casing, the portable radio communication device can be provided as a full metal cover mobile phone by having a metal outer surface essentially all around the mobile phone. In this exemplary embodiment, the first antenna device 100 is the main antenna providing operating band coverage for GSM850, GSM900, GSM1800, GSM1900 and UMTS2100. The second antenna device comprises a first antenna element in the first indentation 300 that functions as a diversity antenna for GSM850, and a second antenna element in the second indentation 400 that functions as a diversity antenna for GSM1900 and UMTS2100. For less frequency band coverage, alternative embodiments may include only a single indentation.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms (e.g., different materials, etc.), and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values (e.g., frequency ranges or bandwidths, etc.) for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). Similarly, it is envisioned that disclosure of two or more ranges of values for a parameter (whether such ranges are nested, overlapping or distinct) subsume all possible combination of ranges for the value that might be claimed using endpoints of the disclosed ranges.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An antenna arrangement for a portable radio communication device having a metal casing, the antenna arrangement comprising:
a first antenna device having a first radiating antenna pattern, the first antenna device comprising the metal casing; and
a second antenna device having a second radiating antenna pattern essentially uncorrelated to the first radiating antenna pattern, the second antenna device is outside the metal casing.

2. The antenna arrangement of claim 1, wherein:
the first antenna device comprises:
a front side part of the metal casing,
a first back side part connected to the front side part through a top side part of the metal casing;
a second back side part connected to the front side part through a bottom side part of the metal casing;
the bottom and top side parts are positioned at opposite ends of the front side part, the first and second back side parts are positioned and distanced from each other by a gap, and the second back side part comprises a feed point positioned at the gap;
the second antenna device comprises a multi-band antenna structure; and
the front side part of the metal casing is a ground plane device shared by the first and second antenna devices.

3. The antenna arrangement of claim 2, wherein the feed point is positioned at a corner at the gap.

4. The antenna arrangement of claim 2, wherein:
the metal casing comprises an indentation; and
the second antenna is arranged in the indentation.

5. The antenna arrangement of claim 2, wherein the second antenna device is arranged off-ground relative to the ground plane device.

6. The antenna arrangement of claim 2, wherein the first back side part comprises a feed point positioned at the gap.

7. The antenna arrangement of claim 6, wherein the feed point of the first back side part is positioned adjacent the feed point of the second back side part.

8. The antenna arrangement of claim 2, wherein the first and second back side parts comprises edge portions folded towards the front side part.

9. The antenna arrangement of claim 2, wherein the first and/or the second back side parts protrude outside of the front side part.

10. The antenna arrangement of claim 2, wherein the first and second back side parts have gap edge profiles that are mirror-shaped.

11. The antenna arrangement of claim 2, wherein the first and the second back side parts are coplanar.

12. The antenna arrangement of claim 1, wherein:
the first antenna device has a far-field radiating antenna pattern that is directive; and
the second antenna device has a far-field radiating antenna pattern that is non-directive.

13. The antenna arrangement of claim 1, wherein:
the first antenna device is a main antenna; and
the second antenna device is a diversity antenna for at least some operating frequencies of the main antenna.

14. The antenna arrangement of claim 1, wherein:
the second antenna device is a main antenna; and
the first antenna device is a diversity antenna for at least some operating frequencies of the main antenna.

15. A portable radio communication device comprising an antenna arrangement according to claim 1.

16. A portable radio communication device comprising:
a metal casing including a front side part, a first back side part connected to the front side part through a top side part of the metal casing, and a second back side part connected to the front side part through a bottom side part of the metal casing, the top and bottom side parts are positioned at opposite ends of the front side part, the first and second back side parts are positioned and distanced from each other by a gap;
a first antenna device having a first radiating antenna pattern, the first antenna device comprising the metal casing;
a second antenna device having a second radiating antenna pattern, the second antenna device outside the metal casing; and
the front side part of the metal casing is operable as a ground plane device shared by the first and second antenna devices.

17. The portable radio communication device of claim 16, wherein:
the first back side part comprises a feed point positioned at the gap, the second back side part comprises a feed point positioned at the gap, and the feed point of the first back side part is positioned adjacent the feed point of the second back side part; and/or
the metal casing comprises an indentation, and the second antenna is arranged in the indentation; and/or
the second antenna device is arranged off-ground relative to the ground plane device.

18. The portable radio communication device of claim 16, wherein:
the first antenna device has a far-field radiating antenna pattern that is directive, and the second antenna device has a far-field radiating antenna pattern that is non-directive; and/or
one of the first and second antenna devices is a main antenna, and the other one of the first and second antenna devices is a diversity antenna for at least some operating frequencies of the main antenna.

19. A radio communication device comprising:
a metal casing including a front side part, a first back side part connected to the front side part through a top side part of the metal casing, and a second back side part connected to the front side part through a bottom side part of the metal casing, the top and bottom side parts are positioned at opposite ends of the front side part, the first and second back side parts are positioned and distanced from each other by a gap;
a first antenna device having a first radiating antenna pattern, the first antenna device comprising the metal casing;
a second antenna device having a second radiating antenna pattern, the second antenna device outside the metal casing;
the front side part of the metal casing is operable as a ground plane device shared by the first and second antenna devices;
whereby the first antenna device has a far-field radiating antenna pattern that is directive, and the second antenna device has a far-field radiating antenna pattern that is non-directive; and/or
whereby one of the first and second antenna devices is a main antenna, and the other one of the first and second antenna devices is a diversity antenna for at least some operating frequencies of the main antenna.

20. The radio communication device of claim 19, wherein:
the first back side part comprises a feed point positioned at the gap, the second back side part comprises a feed point positioned at the gap, and the feed point of the first back side part is positioned adjacent the feed point of the second back side part; and/or
the metal casing comprises an indentation, and the second antenna is arranged in the indentation; and/or
the second antenna device is arranged off-ground relative to the ground plane device.
